(19) United States
(12) Patent Application Publication
(10) Pub. No.: US 2021/0197463 A1
(43) Pub. Date: Jul. 1, 2021

(54) ACTUATABLE PLATENS

(71) Applicant: HEWLETT-PACKARD DEVELOPMENT COMPANY, L.P., Spring, TX (US)

(72) Inventors: Jeremy BARRIBEAU, Vancouver, WA (US); Adam L. HORNSTEIN, San Diego, CA (US); Shannon MIRANDA, Vancouver, WA (US)

(73) Assignee: HEWLETT-PACKARD DEVELOPMENT COMPANY, L.P., Spring, TX (US)

(21) Appl. No.: 16/075,655

(22) PCT Filed: Apr. 12, 2017
(86) PCT No.: PCT/US2017/027232

§ 371 Date: Aug. 5, 2018

(51) Int. Cl. B29C 64/245; B29C 64/232; B29C 64/393; B33Y 30/00; B33Y 50/02

(52) U.S. Cl. CPC B29C 64/245; B29C 64/232; B33Y 10/00; B33Y 30/00; B33Y 50/02; B29C 64/393

(57) ABSTRACT

Example implementations relate to an actuateable motor and platen. In some examples, an apparatus may include a build bucket including a platen disposed therein, a part identification mechanism, and a motor coupled to the platen. The motor may be actuateable to, after a fabricated part is completed within the build bucket, alter a height of the platen responsive to receipt of information determined by the part identification mechanism. In some examples, the information may correspond to a fabricated part disposed in the build bucket.

### BACKGROUND

Additive manufacturing, known as three-dimensional (3D) printing, enables 3D parts to be fabricated layer-by-layer based on a 3D model of the part or parts to be fabricated. One type of 3D printing involves forming successive layers of a build material, such as a powdered build material, and successively solidifying portions of each layer of the build material to form each layer of the part or parts being fabricated.

### BRIEF DESCRIPTION OF THE DRAWINGS

FIG. 1A illustrates an example of an apparatus consistent with the disclosure.

FIG. 1B illustrates another example of an apparatus consistent with the disclosure.

FIG. 2 illustrates an example of an apparatus including an actuateable platen consistent with the disclosure.

FIG. 3 illustrates an example of an apparatus including an actuateable platen where a height of the platen has been altered consistent with the disclosure.

FIG. 4 illustrates an example of an apparatus including a motor, actuateable platen, and fabricated parts consistent with the disclosure.

FIG. 5 illustrates an example of an apparatus including a motor, an actuateable platen, and a fabricated part consistent with the disclosure.

FIG. 6 illustrates an example flow diagram illustrating an example of a method for an actuatable platen consistent with the disclosure.

FIG. 7 illustrates an example of a non-transitory medium storing instructions regarding an actuateable platen consistent with the disclosure.

### DETAILED DESCRIPTION

A printer such as a three-dimensional (3D) printer may include various components to facilitate printing of a fabricated part (e.g., a 3D printed object). For examples, a 3D printer may include various components to print the fabricated part such as a build surface, a build bucket in which a platen is disposed, and a motor to actuate the platen during printing of the fabricated part. As used herein, “disposed” refers to a state of being arranged and/or located at a particular position. For example, the platen being disposed in the build bucket refers to the platen being located inside the build bucket. In some examples, the build bucket may be an integral part of the 3D printer; however, in some examples, the build bucket may be removable or detachable from the 3D printer.

In some approaches, the platen may be actuated by the motor such that the paten moves upward and/or downward along a vertical direction during printing of a fabricated part. For example, during an additive 3D printing process or a fused deposition modeling 3D printing process, the platen may be actuated to move the part being fabricated to a position inside the build bucket where a nozzle that is adding the printing material or ejecting molten material is located. For example, during a 3D printing process, the nozzle/extruder may move in a first and/or second horizontal direction while the platen moves in a vertical direction. As the platen moves in the vertical direction, layers of material may be deposited by the nozzle/extruder to print a fabricated part. Although specific 3D printing processes are discussed above, other 3D printing techniques such as laser sintering (e.g., selective laser sintering, metal laser sintering, etc.), stereolithography, continuous liquid interface production, etc. are contemplated within the scope of the disclosure.

In some examples, the 3D printing process may be a powder based 3D printing process. In such examples, after a 3D printing process is completed, a volume of fused build material and a volume of unfused build material may remain in the build bucket. The unfused build material may be at least partially separated from the fused material using a vibration mechanism and a sieve arrangement, for example. In some examples, the fused build material may comprise the fabricated part, which may be recovered from the build bucket as described herein.

In general, once the 3D printing process has been completed, the platen may be stopped (e.g., actuation of the platen may cease) at the location where the printing process is completed. For example, if the printing process completes when the platen is stopped at the bottom of the build bucket, the platen may remain at the bottom of the build bucket after the printing process is completed. Similarly, if the platen is located at some position between the bottom of the build bucket and the build surface, the platen may remain at that position after the printing process has completed. As used herein, a “platen” is sturdy plate or platform on which a fabricated part is created as part of a 3D printing process.

In such approaches, a user may experience difficulty retrieving the fabricated part from the 3D printer with the platen stopped at the location where the printing process is complete. This may be due to the design of the 3D printer. For example, users of certain heights may experience difficulty and/or physical strain while retrieving the fabricated part if the platen is located at a sufficiently “low” (e.g., close to the bottom of the build bucket) position after printing the fabricated part. More specifically, shorter users may have to stretch and or raise up on their toes to retrieve the fabricated part, and/or may not be able to see or locate smaller fabricated parts, which may subsequently be left in the printing device. On the other hand, taller users may have to bend their knees, hunch their backs, and/or round their back or shoulders to retrieve a fabricated part from the printing device. In addition, taller users may strike their heads on lids, hatches, or other objects that may be positioned above the printing device.

In contrast, examples herein are directed to actuateable platens. In various examples, such actuateable platens may include a platen actuateable by a motor to automatically raise the platen to a height from the bottom of the build bucket that allows for users to more easily see, reach, and/or retrieve fabricated parts from the printing device. In at least one example, the platen may be raised to a height such that a fabricated part is above the build surface so as to be clearly visible to a user and/or a window may be provided in the printer such that a fabricated part is clearly visible to a user. In some examples, the window may be provided on a lid of the printer in order to allow a user to see the fabricated part without having to open the lid.

In some examples, the platen may be actuated automatically without input from a user. For example, the platen may be actuated in response to completion of a fabricated part. Once the platen has been actuated to move the fabricated part to a position that is clearly visible to a user, the platen may be further actuated responsive to a determination that one or more additional fabricated parts are still disposed on the platen. Accordingly, in some examples, the platen may be actuated successively to bring fabricated parts to a position that is visible to the user.

In some examples, an apparatus may include a build bucket including a platen disposed therein, a part identification mechanism, and a motor coupled to the platen. The motor may be actuateable to, after a fabricated part is completed, alter a height of the platen responsive to receipt of information determined by the part identification mechanism. In some examples, the information may correspond to the fabricated part, which may be disposed in the build bucket. As used herein, a “build bucket” is a housing in which fabrication of a 3D printed part takes place.

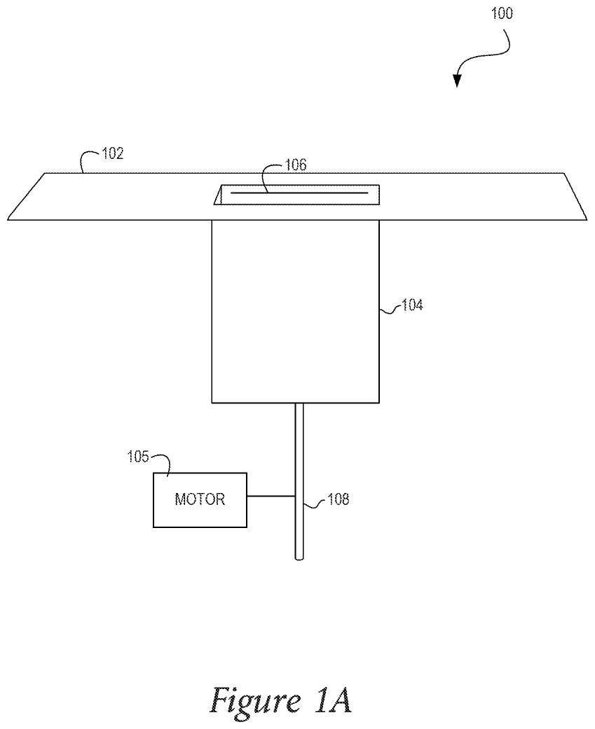

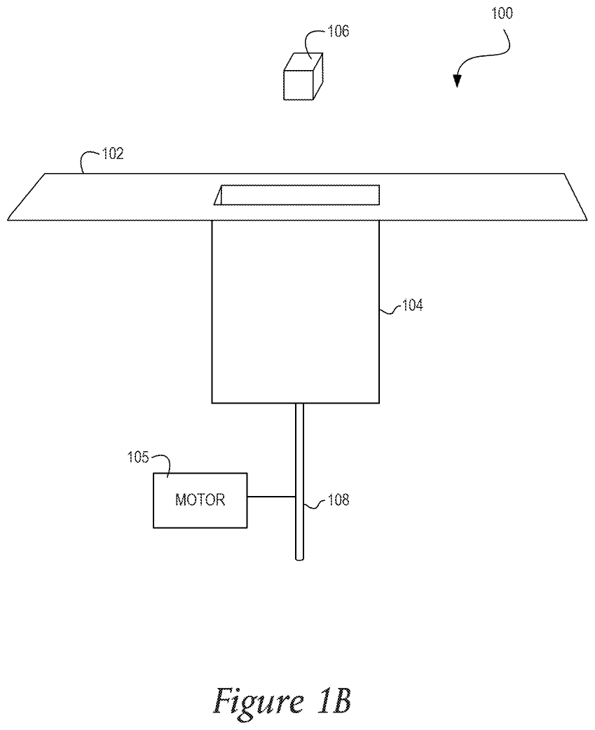

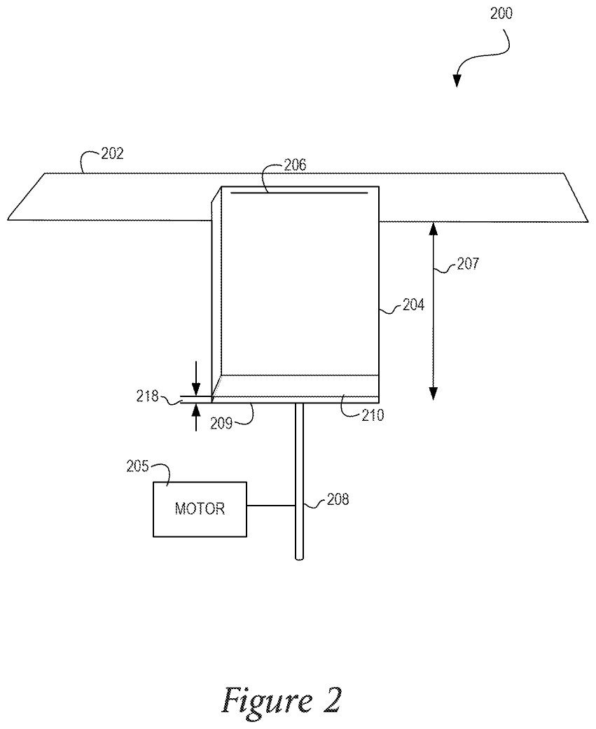

FIG. 1A illustrates an example of an apparatus 100 consistent with the disclosure. As shown in FIG. 1A, the apparatus 100 includes a build surface 102, a build bucket 104, a motor 105, a part identification mechanism 106, and a platen lift mechanism 108. In some examples, the platen lift mechanism 108 may be coupled to a platen (e.g., platen 210 illustrated in FIG. 2). In the example of FIG. 1A, the part identification system 106 may include a sensor such as a beam-break sensor. As used herein, the term “mechanism” refers to a part or system of parts to perform a particular task. Examples of mechanisms can include a processing resource to execute instructions stored on a memory resource, mechanical parts, such as the platen lift mechanism, and/or combination thereof. As used herein, a “build surface” is a horizontal surface of a 3D printer located above (in relation to a floor on which the printer is positioned) the build bucket.

As described in more detail in connection with FIGS. 2-5, herein, the motor 105 may be actuated to cause the platen to raise or lower inside the build bucket 104. For example, the motor 105 may be actuated to cause the platen lift mechanism 108 to move upward or downward inside the build bucket 104, thereby causing the platen to move upward or downward inside the build bucket 104.

In some examples, the motor 105 may be actuated to cause the platen to be raised to a position inside the build bucket 104 that is neither flush to, nor above, the build surface 102. This may reduce a risk that smaller fabricated parts fall off the platen and/or may reduce a risk that printing material spills off of the platen and onto the build surface.

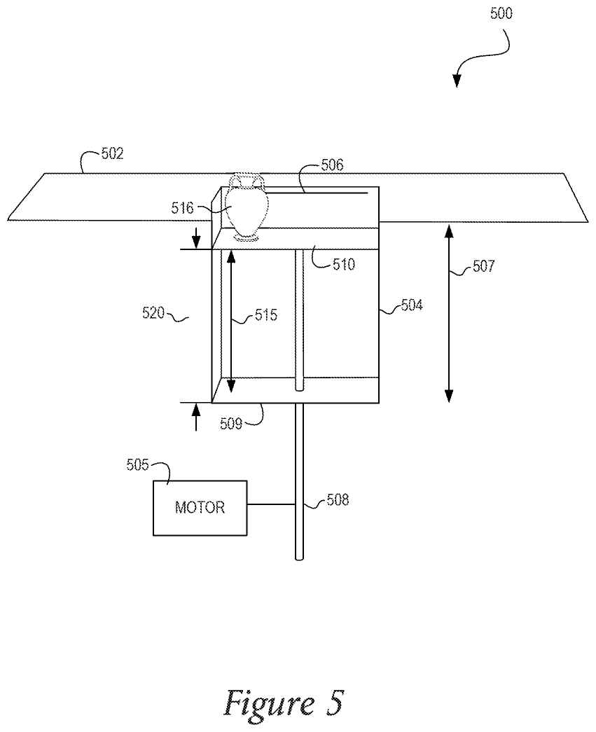

FIG. 1B illustrates another example of an apparatus 100 consistent with the disclosure. As shown in FIG. 1B, the apparatus 100 includes a build surface 102, a build bucket 104, a motor 105, a part identification mechanism 106, and a platen lift mechanism 108. In some examples, the platen lift mechanism 108 may be coupled to a platen (e.g., platen 210 illustrated in FIG. 2). In the example of FIG. 18, the part identification system 106 may include a camera, as discussed in more detail in connection with FIG. 5-7, herein. As shown in FIG. 1B, the part identification system may be located above the build bucket 104 such that the part identification system is provided with a line of sight to the build bucket 104 and/or the platen.

FIG. 2 illustrates an example of an apparatus 200 including a motor 205 and actuateable platen 210 consistent with the disclosure. In the example of FIG. 2, the front facing portion of the build bucket 204 is not shown in order to show and describe the platen 210 and operation thereof. As shown in FIG. 2, the apparatus 200 includes a build surface 202, build bucket 204, motor 205, part identification mechanism 206, platen lift mechanism 208, build bucket floor 209, and platen 210. The platen 210 may be located at a first distance 218 from the build bucket floor 209, and the build surface 202 may be located at a particular distance 207 from the build bucket floor 209. In some examples, the platen 210 may be located at the first distance 218 form the build bucket floor 209 after a printing operation is completed.

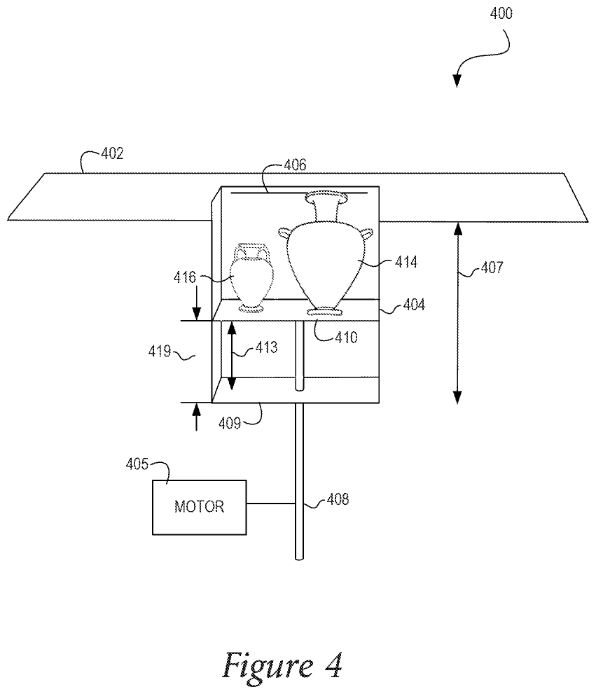

In some examples, the part identification mechanism 206 may include a sensor (e.g., a beam-break sensor) and/or a camera. As discussed in more detail in connection with FIGS. 4 and 5, herein, the part identification mechanism 206 may be to generate and/or receive information related to a fabricated part. Examples of information related to the fabricated part may include a height of the fabricated part, material of the fabricated part, or other characteristics of the fabricated part that may allow for identification of the fabricated part. In some examples, the information related to the fabricated part may include information contained in a build file that is used as part of the printing operation. The build file may be stored in a memory resource associated with the apparatus. As used herein, a “build file” is a set of instructions, image file, or other suitable file that is used by a 3D printer to print a fabricated part.

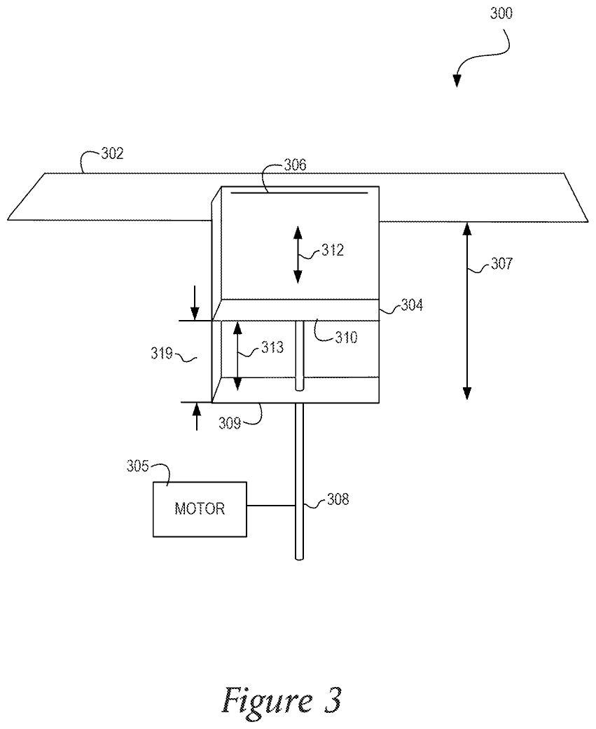

FIG. 3 illustrates an example of an apparatus 300 including a motor 305 and actuateable platen where a height 319 of the platen 310 has been altered consistent with the disclosure. In the example of FIG. 3, the front facing portion of the build bucket 304 is not shown in order to show and describe the platen 310 and operation thereof. As shown in FIG. 3, the apparatus 300 includes a build surface 302, build bucket 304, motor 305, part identification mechanism 306, build bucket floor 309, and platen 310.

The platen 310 may be located at a second distance 319 from the build bucket floor 309. In some examples, the platen 210 may be located at the first distance 218 form the build bucket floor 209 after a printing operation is completed. In addition, as illustrated in FIG. 3, the platen 310 may be actuated (e.g., by motor 305 and/or platen lift mechanism 308) upwards or downwards in the build bucket 304 in a vertical direction as indicated by arrow 312.

In some examples, the platen 310 may have been raised from the first height (e.g., first distance 218 illustrated in FIG. 2) to the second height 313 (e.g., distance 319 from the build bucket floor 309) responsive to a determination that a printing job is finished and the resulting fabricated part is ready to be removed from the apparatus 300. In some examples, the second distance 313 may be located between the build bucket floor 309 and the build surface 302.

FIG. 4 illustrates an example of an apparatus 400 including an motor 405, actuateable platen 410, and fabricated parts 414/416 consistent with the disclosure. In the example of FIG. 4, the front facing portion of the build bucket 404 is not shown in order to show and describe the platen 410 and operation thereof. As shown in FIG. 4, the apparatus 400 includes a build surface 402, build bucket 404, motor 405, part identification mechanism 406, platen lift mechanism 408, build bucket floor 409, and platen 410. The platen 410 may be located at a second distance 419 from the build bucket floor 409.

In some examples, the platen 410 may be located at the second distance 419 from the build bucket floor 409 as a result of the motor 405 and/or platen lift mechanism 408 being actuated to raise (or lower) the platen 410 from a position the platen 410 was in at the conclusion of printing fabricated parts (e.g., first distance 218 from the build bucket floor 209 illustrated in FIG. 2) 414 and 416 responsive to the part identification mechanism 406 determining information related to first fabricated part 414 and/or second fabricated part 416.

For example, the motor 405 may be actuatable to alter the height of the platen 410 from a first height (e.g., a first distance 218 from the build bucket floor 209 illustrated in FIG. 2) to a second height 413 (e.g., second distance 419 from the build bucket floor 409). In some examples, the first height is closer to a build bucket floor 409 of the apparatus than the second height 413 and/or the second height is not higher than or equal to a height of a build surface 402 associated with the apparatus 400.

FIG. 5 illustrates an example of an apparatus 500 including a motor 505, an actuateable platen 510, and a fabricated part 516 consistent with the disclosure. In the example of FIG. 5, the front facing portion of the build bucket 504 is not shown in order to show and describe the platen 510 and operation thereof. As shown in FIG. 5, the apparatus 500 includes a build surface 502, build bucket 504, motor 505, part identification mechanism 506, platen lift mechanism 508, build bucket floor 509, and platen 510. The platen 510 may be located at a third distance 520 from the build bucket floor 509. The build surface 502 may be located at a distance 507 from the build bucket floor 509.

For example, the motor 505 may be actuatable to alter the height of the platen 510 from the second height 413 (e.g., second distance 419 from the build bucket floor 409 illustrated in FIG. 4) to a third height 515 (e.g., third distance 520 from the build bucket floor 509) responsive to a determination by the part identification mechanism 506 that an additional fabricated part 516 is disposed in the build bucket 504. In some examples, the third height 515 may be between the second height (e.g., second height 413 illustrated in FIG. 4) and the build surface 502.

In some examples, the part identification mechanism 506 may include a camera (e.g., as shown in FIG. 1B), which may include a charged coupled device (CCD) and/or a complementary metal-oxide semiconductor (CMOS). The camera may be positioned such that it has a view of the build bucket 504 and/or the platen 510. The camera may be used to determine if a fabricated part 516, obstruction located in the build bucket 504, or print material is left on the platen 510. In some examples, such parts, obstructions, or material being disposed on the platen 510 may cause harm to the printer and/or failure of an upcoming print operation and the determination that such objects are present on the platen 510 may allow for removal of such objects prior to executing a future print operation.

An image recorded by the camera may be processed as part of the determination. For example, suitable image processing techniques such as image differencing or image subtraction may be used. These image processing techniques may allow for an image to be recorded and compared to a current state of the environment. By comparing the image to the current state of the environment, a determination may be made that a fabricated part, obstruction, and/or print material is left on the platen 510 after a print operation is completed. Such information may be used independently or in combination with other sensors to make such determinations. In some examples, these determinations may inform the printer actions (or lack thereof) and/or provide a message to a user. The message may be displayed on a control panel of the printer, or may be provided via light indicators, sounds, and/or remote notification systems such as email, pop-ops, mobile apps, computer software, etc.

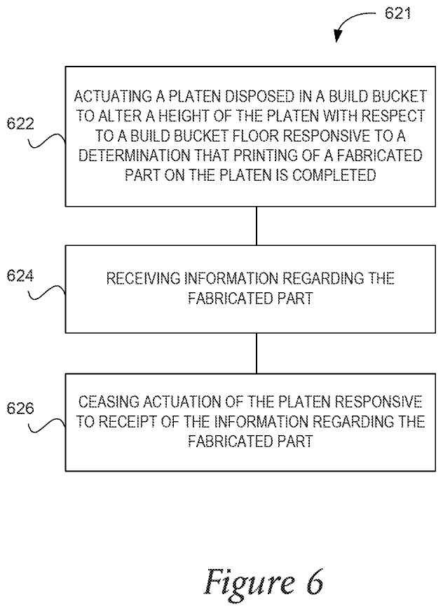

FIG. 6 illustrates an example flow diagram illustrating an example of a method 621 for an actuatable platen consistent with the disclosure. At 622, the method 621 may include actuating a platen disposed in a build bucket to alter a height of the platen with respect to a build bucket floor responsive to a determination that printing of a fabricated part disposed on the platen is completed.

At 624, the method 621 may include receiving information regarding the fabricated part. The received information may include information regarding a height of the fabricated part, a material the fabricated part is made of, etc. In some examples, the method 621 may include receiving the information regarding the fabricated part via a sensor and/or a camera coupled to the build bucket.

At 626, the method 621 may include ceasing actuation of the platen responsive to receipt of the information regarding the fabricated part. In some examples, the information regarding the fabricated part may include information regarding a position of the fabricated part with respect to the build bucket. In some examples, the information regarding the fabricated part may include information regarding a distance of the fabricated part from a build surface, the build surface being located at a particular height above the build bucket floor.

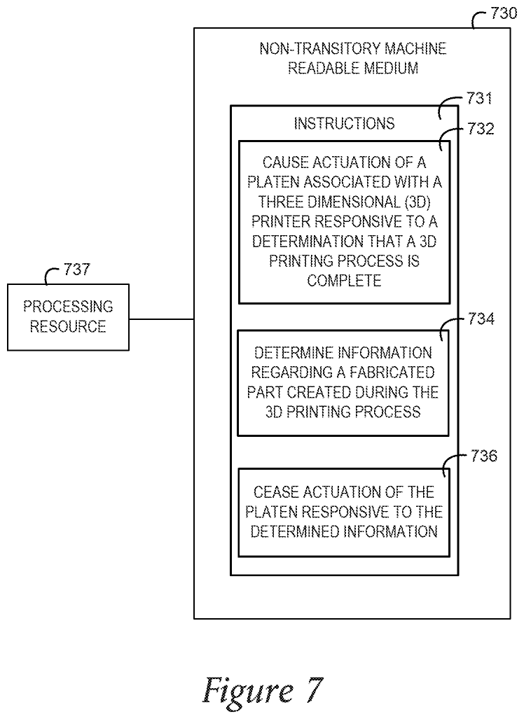

FIG. 7 illustrates an example of a non-transitory medium 730 storing instructions 731 regarding an actuateable platen consistent with the disclosure. The non-transitory machine readable medium 730 may be any type of volatile or non-volatile memory or storage, such as random access memory (RAM), flash memory, read-only memory (ROM), storage volumes, a hard disk, or a combination thereof. In some examples, at 732, the instructions 731 may be executable to cause actuation of a platen associated with a three-dimensional (3D) printer responsive to a determination that a 3D printing process is complete.

At 734, the instructions 731 may be executable by a processing resource 737 to determine information regarding a fabricated part created during the 3D printing process. The received information may include information regarding a height of the fabricated part, a material the fabricated part is made of, etc. In some examples, the method 621 may include receiving the information regarding the fabricated part via a sensor and/or a camera coupled to the build bucket.

At 736, the instructions 731 may be executable by a processing resource 737 to cease actuation of the platen responsive to the determined information. For example, the instruction 731 may be executable by a processing resource 737 to cease actuation of the platen at a height lower than a height associated with a build surface of the 3D printer.

In some examples, the instruction 731 may be executable by a processing resource 737 to determine the information regarding the fabricated part based on receipt of information from a sensor and/or a camera coupled to the 3D printer. As described above, the sensor may include a beam-break sensor and/or the camera may include a CCD and/or CMOS sensor. In some examples, the information regarding the fabricated part may include a height of the fabricated part, a material of the fabricated part, and/or a position of the fabricated part relative to a build bucket floor of the 3D printer.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. An apparatus, comprising:
a build bucket including a platen;
a part identification mechanism; and
a motor coupled to the platen, the motor actuateable to, after a fabricated part is completed within the build bucket, alter a height of the platen responsive to receipt of information determined by the part identification mechanism, the information corresponding to the fabricated part.

2. The apparatus of claim 1, wherein the part identification mechanism comprises a sensor, and the information corresponding to the fabricated part includes information regarding the fabricated part as determined by the sensor.

3. The apparatus of claim 2, wherein the sensor comprises a beam-break sensor.

4. The apparatus of claim 1, wherein the information corresponding to the fabricated part includes information from a build file associated with the fabricated part.

5. The apparatus of claim 1, wherein the motor is actuatable to alter the height of the platen from a first height to a second height, wherein the first height is closer to a build bucket floor of the apparatus than the second height and wherein the second height is not higher than or equal to a height of a build surface associated with the apparatus.

6. The apparatus of claim 5, wherein the motor is actuatable to alter the height of the platen from the second height to a third height responsive to a determination by the part identification mechanism that an additional fabricated part is disposed in the build bucket, the third height being between the second height and the build surface.

7. A method, comprising:
actuating a platen disposed in a build bucket to alter a height of the platen with respect to a build bucket floor responsive to a determination that printing of a fabricated part disposed on the platen is completed;
receiving information regarding the fabricated part; and
ceasing actuation of the platen responsive to receipt of the information regarding the fabricated part.

8. The method of claim 7, wherein the information regarding the fabricated part includes information regarding a vertical position of the fabricated part with respect to the build bucket.

9. The method of claim 7, further comprising receiving the information regarding the fabricated part via a sensor coupled to the build bucket.

10. The method of claim 7, further comprising receiving the information regarding the fabricate part via a camera coupled to the build bucket.

11. The method of claim 7, wherein the information regarding the fabricated part includes information regarding a distance of the fabricated part from a build surface, the build surface being located at a particular height above the build bucket floor.

12. A non-transitory machine-readable medium storing instructions executable by a processing resource to:
cause actuation of a platen associated with a three-dimensional (3D) printer responsive to a determination that a 3D printing process is complete;
determine information regarding a fabricated part created during the 3D printing process; and
cease actuation of the platen responsive to the determined information.

13. The non-transitory machine-readable medium of claim 12, wherein the instructions are further executable by the processing resource to cease actuation of the platen at a height lower than a height associated with a build surface of the 3D printer.

14. The non-transitory machine-readable medium of claim 12, wherein the instructions are further executable by the processing resource to determine the information regarding the fabricated part based on receipt of information from a sensor coupled to the 3D printer, and wherein the information includes a material of the fabricated part.

15. The non-transitory machine-readable medium of claim 12, wherein the instructions are further executable by the processing resource to determine the information regarding the fabricated part based on receipt of information from a camera coupled to the 3D printer, and wherein the information includes a position of the fabricated part relative to a build bucket floor of the 3D printer.
